(19) United States
(12) Patent Application Publication
(10) Pub. No.: US 2020/0265439 A1
(43) Pub. Date: Aug. 20, 2020

(54) PREDICTING AND RESOLVING REQUEST HOLDS

(71) Applicant: HIGHRADIUS CORPORATION, Houston, TX (US)

(72) Inventors: Harish Potabathula, Hyderabad (IN); Deepanjan Chattopadhyay, Bangalore (IN); Srinivasa Jami, Telangana (IN); Sonali Nanda, Miyapur (IN); Vishal Shah, Kandivali (W) (IN)

(21) Appl. No.: 16/411,644

(22) Filed: May 14, 2019

(30) Foreign Application Priority Data
Feb. 15, 2019 (IN) 201941006158

(51) Int. Cl. G06Q 20/40; G06Q 40/02

(52) U.S. Cl. CPC G06Q 20/4037; G06Q 40/02; G06Q 20/405

(57) ABSTRACT

A computing device performs a method for predictive resource request hold and proactive hold resolution. The method includes: predicting a request for a resource from a requestor; predicting a hold on fulfilling the request; and determining a preventative action to minimize actualization of the hold on fulfilling the request. Predicting the request for the resource and predicting the hold can be performed using artificial intelligence. The preventative action can include temporarily increasing a credit limit for the requestor. Where the hold is actualized, the method can further include predicting a likelihood of the hold being released and determining whether to release the hold based on whether the likelihood of the hold being released exceeds a release threshold.

### CROSS-REFERENCE TO RELATED APPLICATIONS

This application claims the benefit of Indian Appl. No. 201941006158, filed Feb. 15, 2019. This application is incorporated herein by reference in its entirety to the extent consistent with the present application.

### BACKGROUND

Organizations that provide resources to individuals and other organizations usually have some sort of resource management system to control the flow of resources to requestors. For example, organizations that sell goods or services oftentimes utilize some sort of order management system or mechanism. In general, order management is a collection of processes and actions to successfully deliver a product or service to a customer. These processes and actions typically involve receiving order requests from customers, organizing the order requests, tracking the order requests, and then fulfilling the orders. Organizations may allocate resources, including computing resources, software, and manpower to their order management systems, in part, because streamlined and efficient order management may support increased revenue along with satisfied and repeat customers as a result of customer orders being timely fulfilled. Similarly, some organizations that provide computing resources to individuals and other organizations may have some sort of computing resource management system or mechanism to facilitate timely provisioning of requested resources to requestors.

A part of managing the provisioning of resources includes risk mitigation as relates to the requestor. In the example of the organization providing goods or services, the organization may allow certain customers to order and receive a certain amount of goods or services on “credit.” In this context, “credit” refers to fulfillment prior to payment for the goods or services. However, as a part of the risk mitigation, the organization may limit the amount of credit extended to a particular customer. Credit may be limited based on factors such as the customer's revenue or income, prior credit history, prior payment history with the organization, etc. In the computer resource management example, certain constraints may likewise be placed on a requestor's access to computing resources. In this computer resource management context, a requestor may represent a customer (e.g., of cloud-based resources or another computer process requesting additional resources automatically).

A problem arises, however, when a customer or requestor of resources places an order or request that causes the customer or requestor to exceed an allotted credit or resource limit. In such a case, the customer's order or requestor's request may be placed on hold pending further processing. This further processing may involve additional computing and manpower resources to resolve the hold. Additionally, further processing may delay or may even inhibit revenue flow, for example, if the order or request is denied. Moreover, these holds often lead to decreased customer or requestor satisfaction due to a delay or denial in fulfilling the order or request. These reactive responses to resolving holds are, thus, undesirable for both the organization and the customer or requestor.

### BRIEF DESCRIPTION OF THE DRAWINGS

The present disclosure may be better understood from the following detailed description when read with the accompanying Figures. It is emphasized that, in accordance with standard practice in the industry, various features are not drawn to scale. In fact, the dimensions or locations of functional attributes may be relocated or combined based on design, security, performance, or other factors known in the art of computer systems. Further, order of processing may be altered for some functions, both internally and with respect to each other. That is, some functions may not require serial processing and therefore may be performed in an order different than shown or possibly in parallel with each other. For a detailed description of various examples, reference will now be made to the accompanying drawings, in which:

FIG. 1A depicts a process diagram representing a method that may be implemented as part of predicting if a resource request may be placed on hold, according to one or more examples of the present disclosure;

FIG. 1B depicts a process diagram representing a method that may be implemented as part of predicting an order and predicting whether the order may be placed on hold, according to one or more examples of the present disclosure;

FIG. 2 depicts a computing device with a hardware processor and accessible machine-readable instructions that may be used to execute the request hold prediction and recommendation algorithms illustrated in FIG. 1A;

FIG. 3 depicts a process diagram representing a method 300 that may be implemented as part of predicting if a request that is on hold may be released, according to one or more examples of the present disclosure;

FIG. 4 depicts a computing device with a hardware processor and accessible machine-readable instructions that may be used to execute the held request release prediction algorithm and automatic threshold limit increase illustrated in FIG. 3;

FIG. 5A depicts an inefficient workflow that an analyst might follow without the benefit of methods of predicting if an order may be placed on hold, according to one or more examples of the present disclosure;

FIG. 5B depicts a workflow that an analyst can follow that implements methods for predicting if an order may be placed on hold, according to one or more examples of the present disclosure;

FIG. 6A depicts a functional block diagram of a user interface that may be used to present predicted order holds and recommended actions, according to one or more examples of the present disclosure;

FIG. 6B depicts a functional block diagram of a logical grouping of a data point that contains data that may be used to determine actions to take to prevent an order from being placed on hold or allowing a held order to be released, according to one or more examples of the present disclosure;

FIG. 7A depicts a functional block diagram representing a user interface that may be used to present a recommendation for a preventive action to minimize actualization of a predicted hold, according to one or more examples of the present disclosure;

FIG. 7B depicts a functional block diagram representing an alternate view of the example user interface illustrated in FIG. 7A, according to one or more examples of the present disclosure;

FIG. 7C depicts a functional block diagram representing another alternate view of the example user interface illustrated in FIG. 7A, according to one or more examples of the present disclosure;

FIG. 8 depicts a computer network infrastructure that may be used to implement all or part of the disclosed request hold prediction and held request release prediction algorithms, according to one or more examples of the present disclosure; and

FIG. 9 depicts a computer processing device that may be used to implement the functions, modules, processing platforms, execution platforms, communication devices, and other methods and processes, according to one or more examples of the present disclosure.

### DETAILED DESCRIPTION

Examples of the subject matter claimed below will now be disclosed. In the interest of clarity, not all features of an actual implementation are described in each example of this specification. It will be appreciated that in the development of any such actual example, numerous implementation-specific decisions may be made to achieve the developer's specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Automated systems are provided to predict, using artificial intelligence and machine learning, how to address an order hold scenario for a request for resources, also referred to herein as a resource request. The resource request may be an order of tangible goods or an order for computer resources. For example, a buyer in a business-to-business (“B2B”) transaction places an order apparently in violation of a credit relationship (e.g., credit limit crossing). Systems as disclosed may predict if the order may be placed on hold due to the apparent violation or if temporary waiver of the violation may be acceptable. Similar techniques may be applied to a computer management system where resource constraints are predicted to be violated for an acceptable amount of time (e.g., no system failure). Recommendations may be determined and automatically or manually applied so that the order hold (or resource request denial in the context of a computer management system) may be avoided.

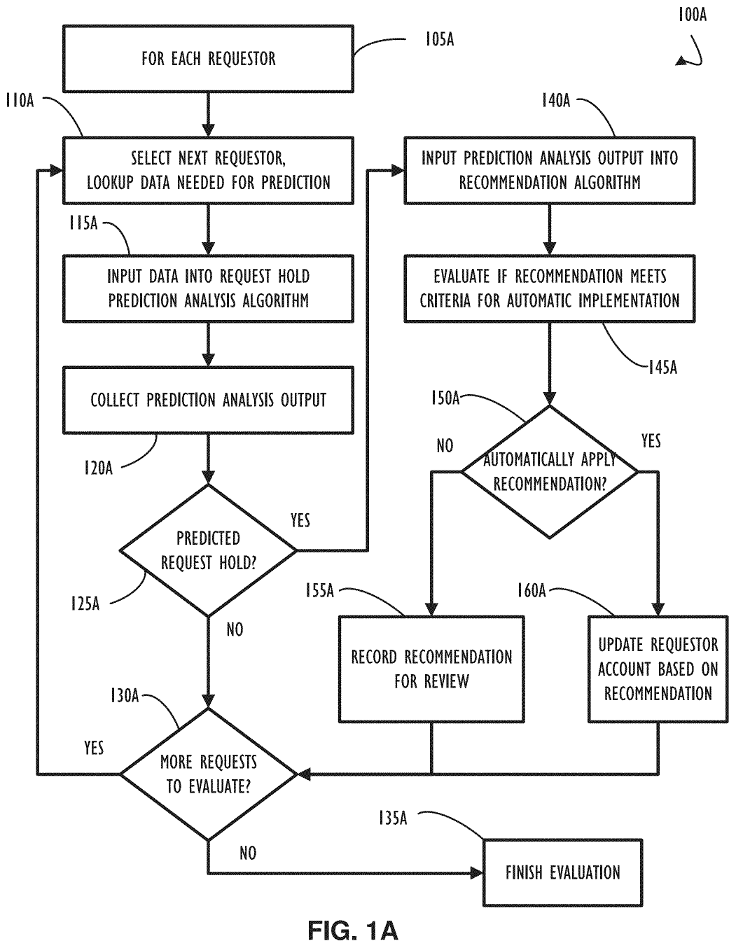

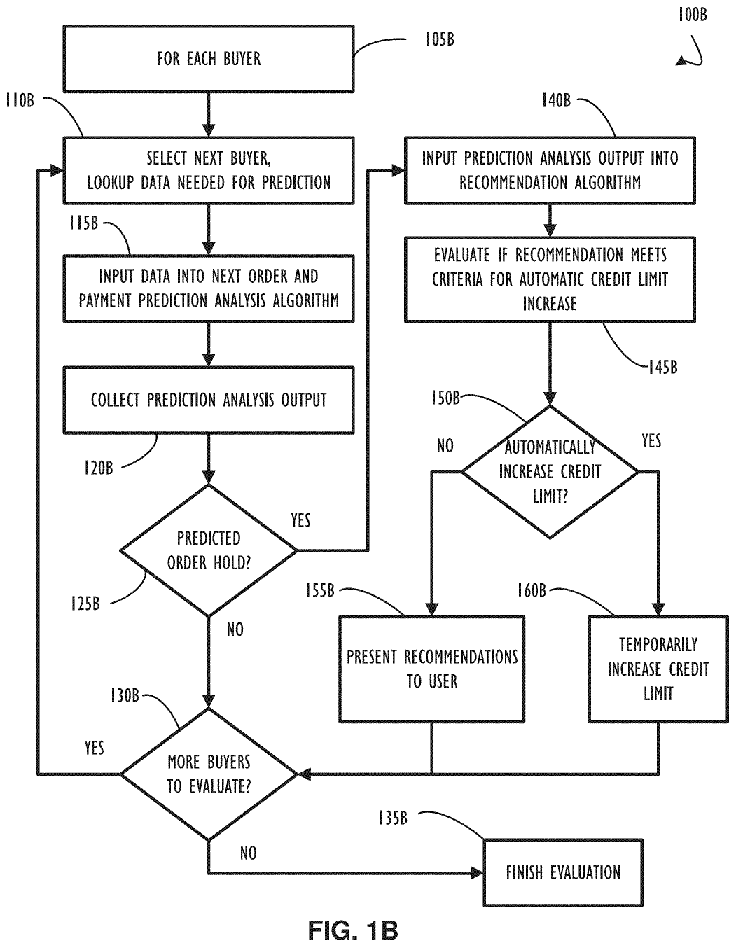

Referring now to FIG. 1A, shown is an example process diagram representing an example method 100A that may be implemented as part of predicting if a resource request, also referred to herein simply as a request, may be placed on hold. Method 100A may also be implemented as part of generating one or more recommendations to prevent the request from being placed on hold. Block 105A indicates that prediction analysis may be performed for one or more requestors of resources from a provider. For instance, prediction analysis may be performed for one or more buyers currently doing business with a seller. In one example, prediction analysis is performed for each requestor of resources from a provider. In an example where the requestor is a buyer, the request can be an order placed by the buyer to a seller. While the process diagram shows an example method 100A that may be performed on a single requestor, in practice method 100A may be applied to multiple requestors simultaneously using parallel computing techniques.

Flow continues to block 110A where predictive analysis begins by retrieving requestor's data to provide as input to a predictive analysis algorithm. The requestor's data may include historical data of previous requests for a resource by the requestor and additional data for the requestor. The additional data may include a resource limit assigned to the requestor (also referred to herein as a threshold limit for the resource), balance history for the requestor (which may include an outstanding payment balance for the requestor), payment history for the requestor, etc. Flow continues to block 115A where the predictive analysis algorithm is invoked using the previously retrieved data for the requestor. Output of the predictive analysis is collected in block 120A. Flow continues to decision 125A where an evaluation of the output of the prediction analysis algorithm is used to determine if a request is predicted to be placed on hold. The predictive algorithm of block 115A may also be used to predict a future request for a resource by the requestor and to predict a hold on fulfilling the future request. If there is no order hold predicted, the NO prong of decision 125A, flow continues to decision 130A. Alternatively, if an order hold is predicted, the YES prong of decision 125A, flow continues to block 140A where a recommendation algorithm uses the prediction analysis algorithm results to determine one or more possible preventative actions to minimize actualization, in other words realization or materialization, of the hold on fulfilling the future request. For instance, the recommendation algorithm may determine one or more recommendations to prevent a request from being placed on hold.

In an example, at least a part of the prediction analysis algorithm may include predicting, based on the historical data of previous requests, a future request for the resource from the requestor and predicting, based on the future request for the resource and the additional data for the requestor, a hold on fulfilling the future request. At least part of the prediction algorithm may also include predicting, based on the payment history, a future payment for the resource and predicting the hold on fulfilling the future request based on the predicted future payment for the resource. Additionally, at least part of the prediction algorithm may also include predicting a date and amount of the future request based on the historical data of previous requests, predicting a date and amount of the future payment based on the payment history, and predicting the hold on fulfilling the future request based on the data and amount of the future request, the date and amount of the future payment, a resource limit, and an outstanding payment balance.

Flow continues to block 145A to evaluate if one or more of the recommendations produced by the recommendation algorithm meets criteria for automatically applying the recommendation without user input. The flow then continues to decision 150A. If decision 150A determines to automatically apply the recommendation, the YES prong of decision 150A, the flow proceeds to block 160A. In block 160A the requestor's account is automatically updated based on the one or more recommendations that met the criteria. Alternatively, the NO prong of decision 150A branches the flow to block 155A. At block 155A, the recommendation can be saved for later presenting to a user, for instance through a user interface. This allows the user to determine whether or not to apply one or more of the recommendations, and then update the requestor's account based on the one or more recommendations. Accordingly, a preventative action can be applied in response to input through the user interface. Decision 125A and blocks 155A and 160A flow to decision 130A after completion. At decision 130A a determination is made to evaluate if more requestors are waiting to have the prediction and recommendation algorithms applied. If there are more requestor's to evaluate, the YES prong of decision 130A, flow continues back to block 110A where the next requestor is chosen. Alternatively, if there are no more requestors to evaluate (e.g., apply the prediction and recommendation algorithms), the NO prong of decision 130A, process flow continues to block 135A where evaluation stops.

Referring now to FIG. 1B, shown is an example process diagram representing an example method 100B that may be implemented as part of predicting if an order may be placed on hold. Method 100B may also be implemented as part of generating one or more recommendations to prevent the order from being placed on hold. Block 105B indicates that prediction analysis may be performed for one or more buyers of resources from a seller. In one example, prediction analysis is performed for each buyer of resources from a seller. While the process diagram shows an example method 100B that may be performed on a single buyer, in practice method 100B may be applied to multiple buyers simultaneously using parallel computing techniques.

Flow continues to block 110B where predictive analysis begins by retrieving the buyer's data to provide as input to a predictive analysis algorithm. Flow continues to block 115B where the predictive analysis algorithm is invoked using the previously retrieved data for the requestor. Output of the predictive analysis is collected in block 120B. For example, the predictive analysis algorithm may predict an amount and a date of a next order and an amount and date of a next payment for the selected buyer. The predictive analysis algorithm may use the predicted next order and predicted next payment to predict whether the anticipated order may be placed on hold. For instance, order history, earlier order holds history, and the buyer's credit profile may be used to predict the amount and date of the next order. Past payment history, payment behavior, and invoice aging may be used to predict the amount and date of the next payment.

Flow continues to decision 125B where an evaluation of the output of the prediction analysis algorithm is used to determine if a predicted order is further predicted to be placed on hold. If there is no order hold predicted, the NO prong of decision 125B, flow continues to decision 130B. Alternatively, if an order hold is predicted, the YES prong of decision 125B, flow continues to block 140B where a recommendation algorithm uses the prediction analysis algorithm results to determine one or more possible recommendations to prevent a predicted order from being placed on hold.

Flow continues to block 145B to evaluate if one or more of the recommendations produced by the recommendation algorithm meets criteria for automatically increasing a credit limit for the buyer. The flow then continues to decision 150B. If decision 150B determines to automatically increase the buyer's credit limit, the YES prong of decision 150B, the flow proceeds to block 160B. In block 160B the buyer's credit limit is temporarily increased. For example, the credit limit may be increased until a predicted payment of the buyer is received. Alternatively, the NO prong of decision 1506 branches the flow to block 155B, where other recommendations may be saved for later presenting to a user. This allows the user to determine whether or not to apply one or more of the recommendations, and then update the buyer's account based on the one or more recommendations. Example recommendations may include requesting an advanced payment for the next order or following up with the buyer for payment.

Decision 125B and blocks 155B and 160B flow to decision 130B after completion. At decision 130B a determination is made to evaluate if more buyers are waiting to have the prediction and recommendation algorithms applied. If there are more buyer's to evaluate, the YES prong of decision 1306, flow continues back to block 1106 where the next buyer is chosen. Alternatively, if there are no more buyers to evaluate (e.g., apply the prediction and recommendation algorithms), the NO prong of decision 130B, process flow continues to block 135B where evaluation stops.

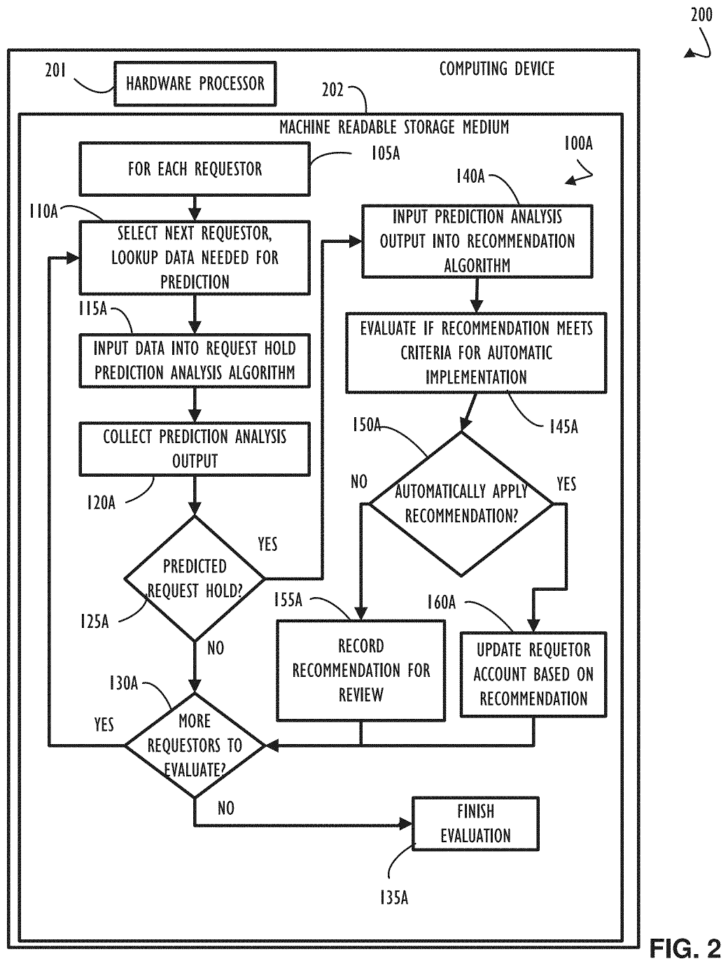

Referring to FIG. 2, shown is an example computing device 200, with a hardware processor 201, and accessible machine-readable instructions stored on a machine-readable medium 202 that may be used to execute the request hold prediction and recommendation method 100A, according to one or more disclosed example implementations. FIG. 2 illustrates computing device 200 configured to perform the flow of method 100A as an example. However, computing device 200 may also be configured to perform the flow of other methods, techniques, functions, or processes described in this disclosure. In this example of FIG. 2, machine-readable storage medium 202 includes instructions to cause hardware processor 201 to perform blocks 105A-160A discussed above with reference to FIG. 1A.

A machine-readable storage medium, such as 202 of FIG. 2, may include both volatile and nonvolatile, removable and non-removable media, and may be any electronic, magnetic, optical, or other physical storage device that contains or stores executable instructions, data structures, program module, or other data accessible to a processor, for example firmware, erasable programmable read-only memory (EPROM), random access memory (RAM), non-volatile random access memory (NVRAM), optical disk, solid state drive (SSD), flash memory chips, and the like. The machine-readable storage medium may be a non-transitory storage medium, where the term “non-transitory” does not encompass transitory propagating signals.

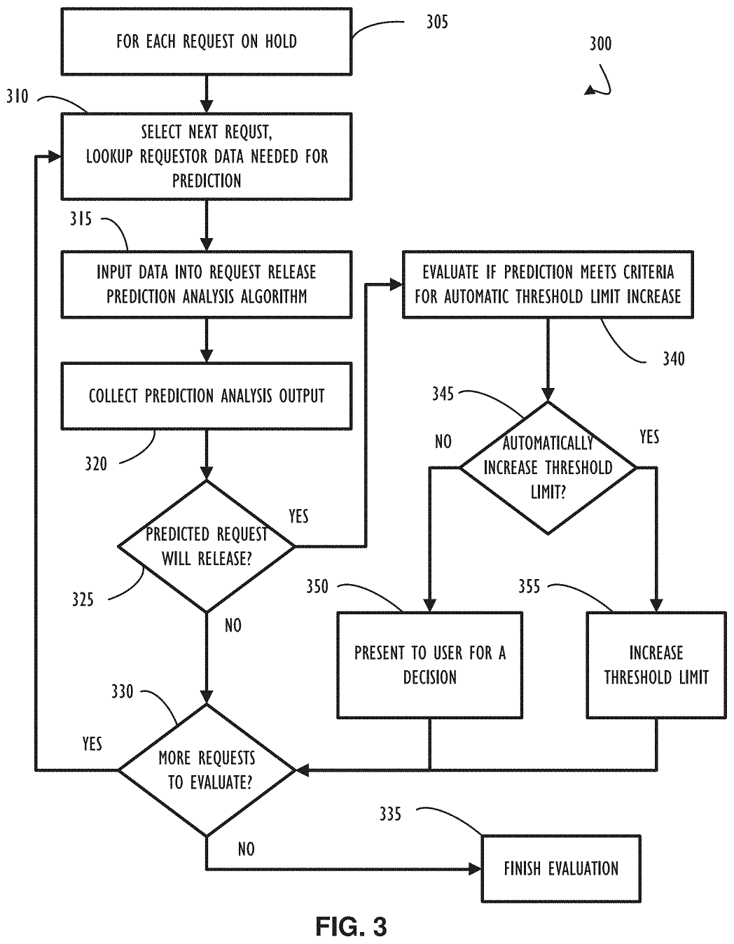

Referring now to FIG. 3, shown is an example process diagram representing an example method 300 that may be implemented as part of predicting if a request that is on hold may be released. For example, the method 300 may also be implemented after detecting actualization of a predicted hold on a predicted future request for a resource to further determine whether the actualized hold may be released. The request may be released, for example, so that the requestor's threshold limit may be increased to, thereby, allow the held request to be released. In the case, wherein the requestor is a buyer, example method 300 may be implemented as part of predicting if an order that is on hold may be released. The hold may be released, for example, so that the buyer's credit limit can be increased to, thereby, allow the held order to be released.

Block 305 indicates that prediction analysis may be performed for one or more requests on hold. In one example, prediction analysis may be performed for each request that is on hold. Each request may represent one of potentially many requests for a single requestor that may be on hold. While the process diagram of FIG. 3 illustrates example method 300 being performed on a single request, in practice method 300 may be applied to multiple requests simultaneously using parallel computing techniques. Flow continues to block 310 where predictive analysis begins by retrieving data for a selected request that is on hold to provide as an input to a predictive analysis algorithm. Flow continues to block 315 where the predictive analysis algorithm is invoked using the previously retrieved data for the selected request. Retrieved data may include additional requests that are on hold for the requestor of the currently selected request. The output of the predictive analysis is collected in block 320. Flow continues to decision 325 where an evaluation of the output of the prediction analysis algorithm determines if one or more requests for the requestor are likely to be released. If there is no held request predicted to be released, the NO prong of decision 325, flow continues to decision 330. Alternatively, if there are held requests that are predicted to be released, the YES prong of decision 325, flow continues to block 340 where the prediction is evaluated for criteria that would allow the requestor's threshold limit to be automatically increased using decision 345. Flow continues from block 340 to decision 345 where the process branches based on the criteria for automatically increasing the requestor's threshold limit.

Still referring to FIG. 3, if the requestor's threshold limit can be automatically increased, the YES prong of decision 345, flow continues to block 355 where the threshold limit is increased. Alternatively, if the requestor's threshold limit is not automatically increased, the NO prong of decision 345, flow continues to block 350 where a decision of whether to increase the requestor's threshold limit can be presented to a user. For example, an interface can be presented to a user at a later time for an indication of authorization to allow the threshold limit increase. Flow continues to decision 330 from decision 325 and blocks 355 and 350 to evaluate if there are more held requests with which the analysis can be performed. The number of requests left to evaluate may be reduced if, for example, the analysis of an initially chosen held request leads to analysis of multiple requests for a single requestor for the purpose of increasing the threshold limit to accommodate the release of multiple held requests for the same requestor. If there are more requests to evaluate, the YES prong of decision 330, flow continues to block 310 where a next request is selected and the analysis process begins again. Alternatively, if there are no more requests to evaluate, the NO prong of decision 330, flow continues to block 335 where the analysis process ends.

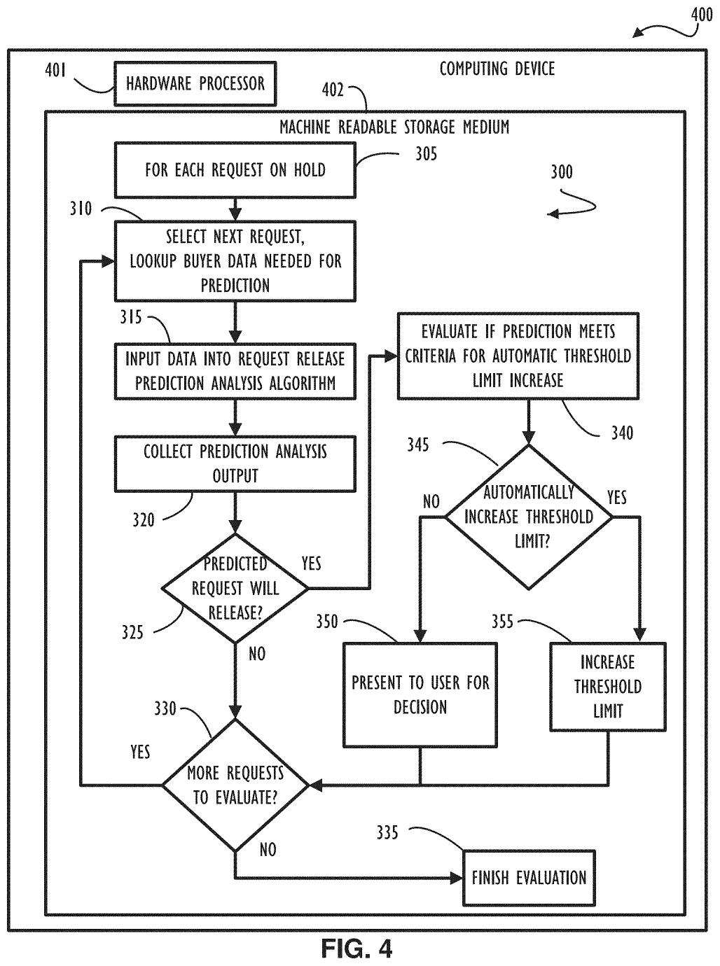

Referring to FIG. 4, shown is an example computing device 400, with a hardware processor 401, and accessible machine-readable instructions stored on a machine-readable medium 402 that may be used to execute the held request release prediction algorithm and automatic credit limit increase, according to one or more disclosed example implementations. FIG. 4 illustrates computing device 400 configured to perform the flow of method 300 as an example. However, computing device 400 may also be configured to perform the flow of other methods, techniques, functions, or processes described in this disclosure. In this example of FIG. 4, machine-readable storage medium 402 includes instructions to cause hardware processor 401 to perform blocks 305-355 discussed above with reference to FIG. 3.

A machine-readable storage medium, such as 402 of FIG. 4, may include both volatile and nonvolatile, removable and non-removable media, and may be any electronic, magnetic, optical, or other physical storage device that contains or stores executable instructions, data structures, program module, or other data accessible to a processor, for example firmware, erasable programmable read-only memory (EPROM), random access memory (RAM), non-volatile random access memory (NVRAM), optical disk, solid state drive (SSD), flash memory chips, and the like. The machine-readable storage medium may be a non-transitory storage medium, where the term “non-transitory” does not encompass transitory propagating signals.

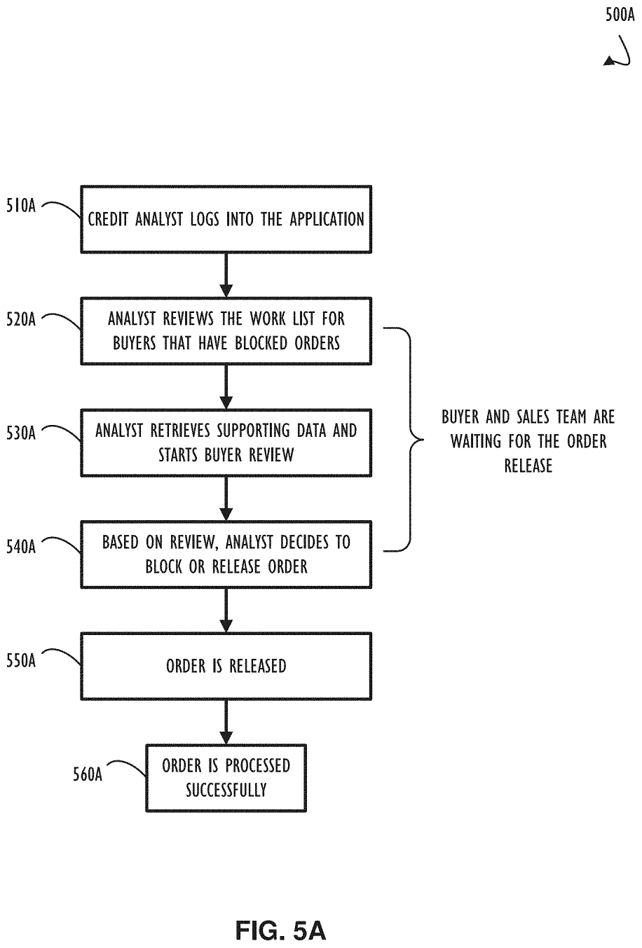

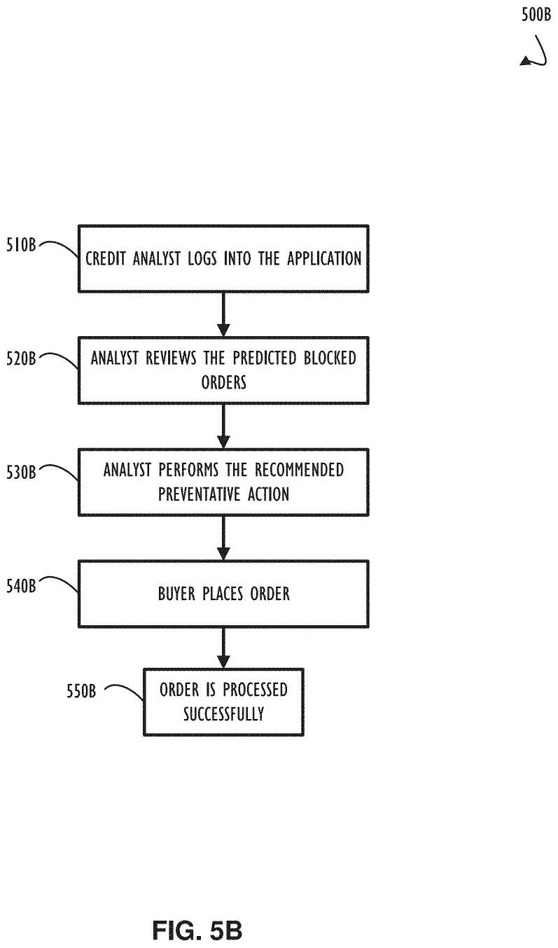

Having an understanding of the above overview with respect to predicting and resolving request holds for a purchasing/procurement system or a system for provisioning computer resources, this disclosure will now explain a non-limiting example that may implement all or parts of the methods 100A, 100B, and/or 300. Accordingly that above description and the concepts and specifics therein apply to the specific example discussed below. Likewise, the following description of the specification example and the concepts therein apply within context of the above description. Accordingly, the description and concepts and specifics therein with respect to FIGS. 5B, 6A, 6B, 7A, 7B, and 7C also apply with respect to predicting and resolving request holds for a purchasing/procurement system or a system for provisioning computer resources.

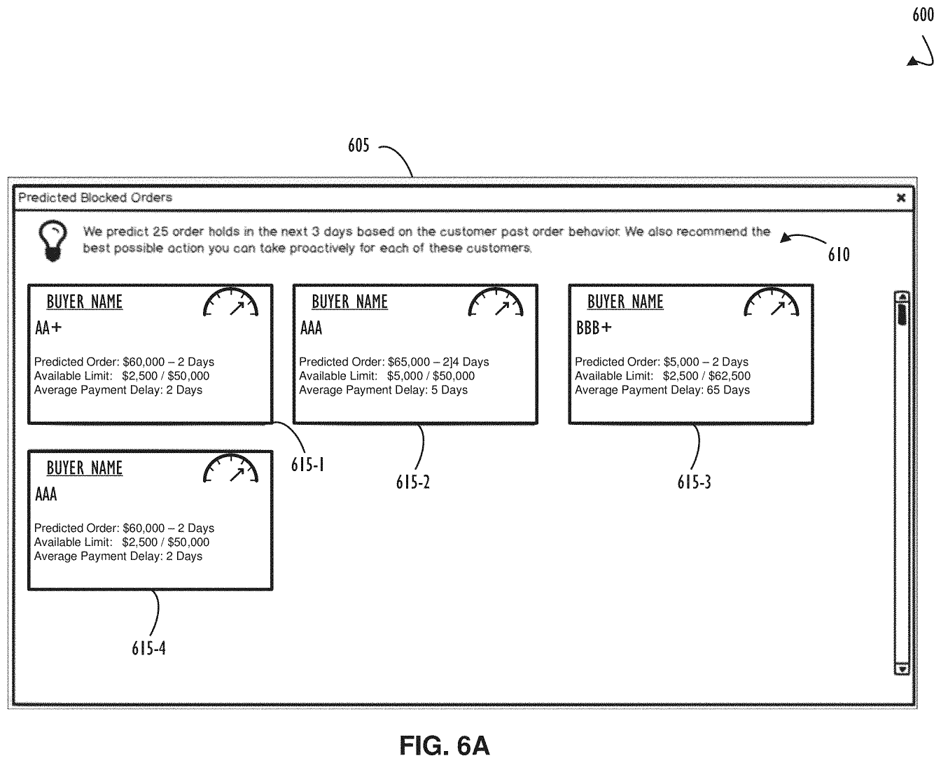

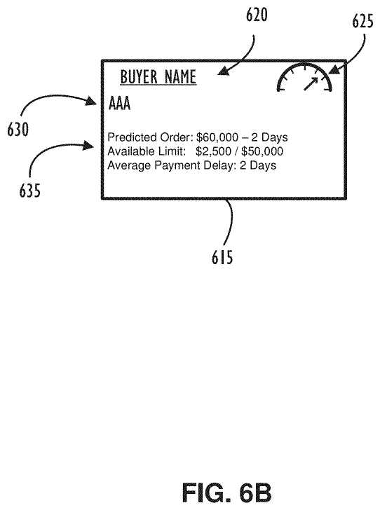

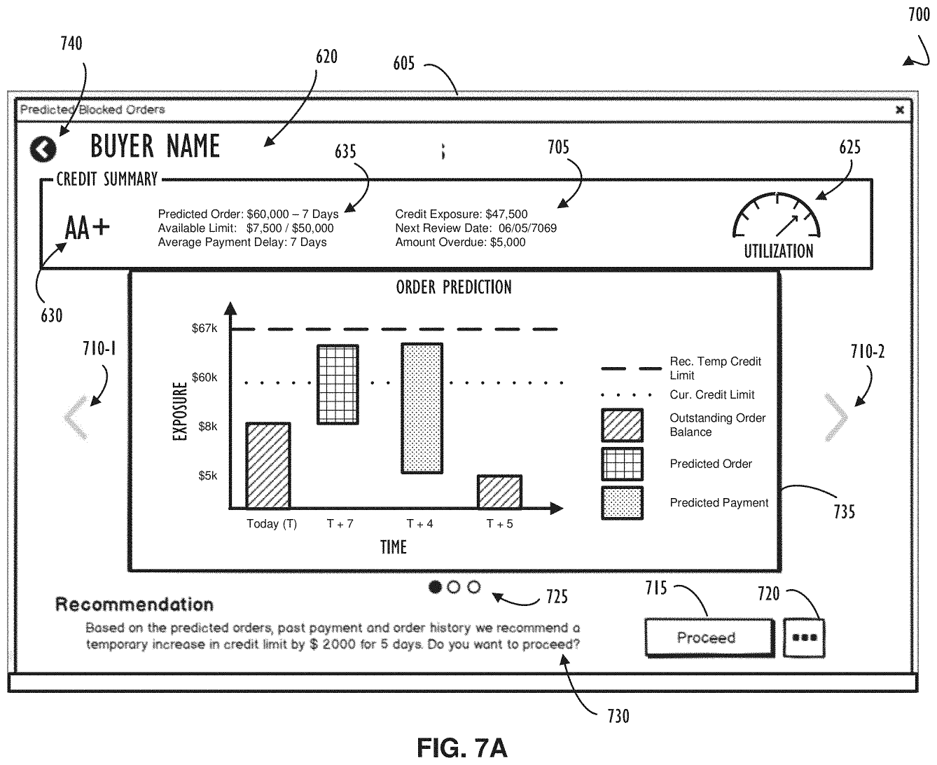

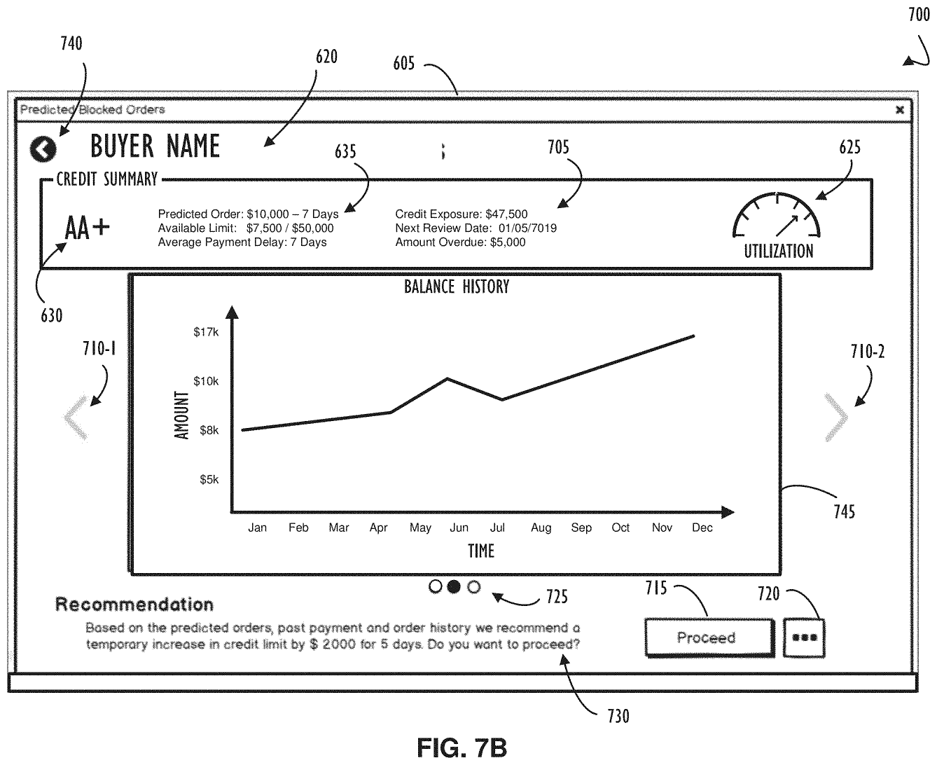

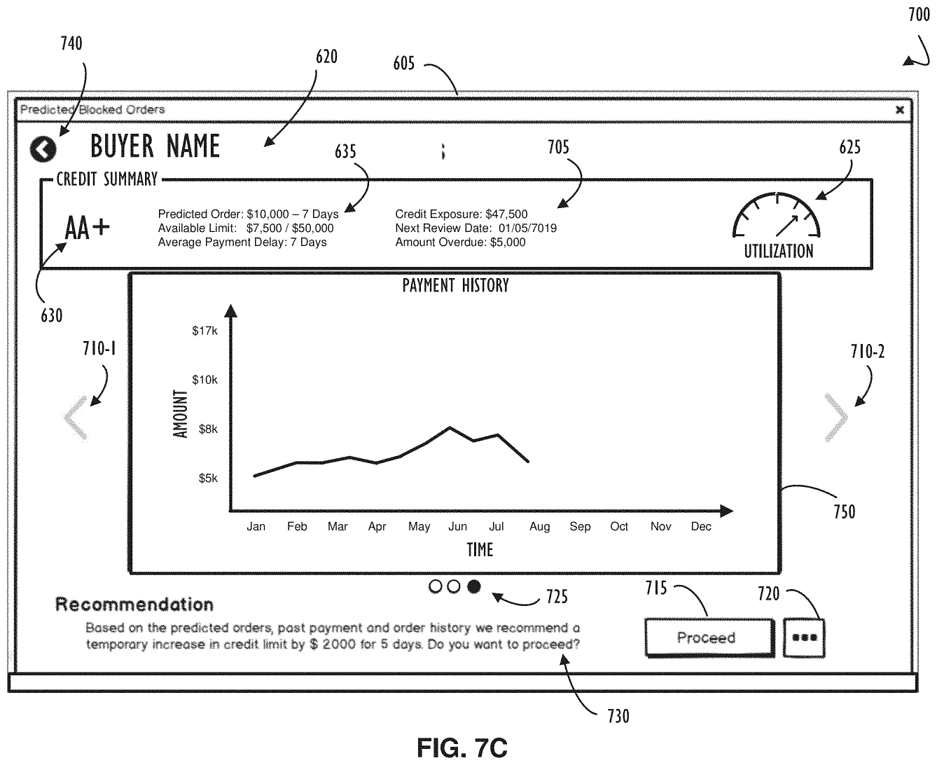

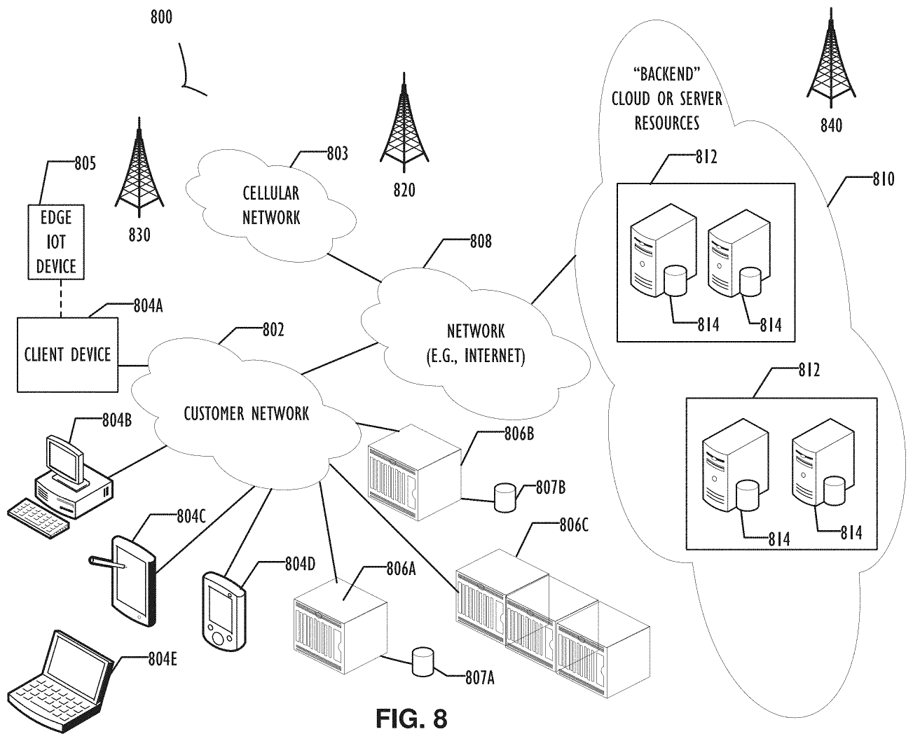

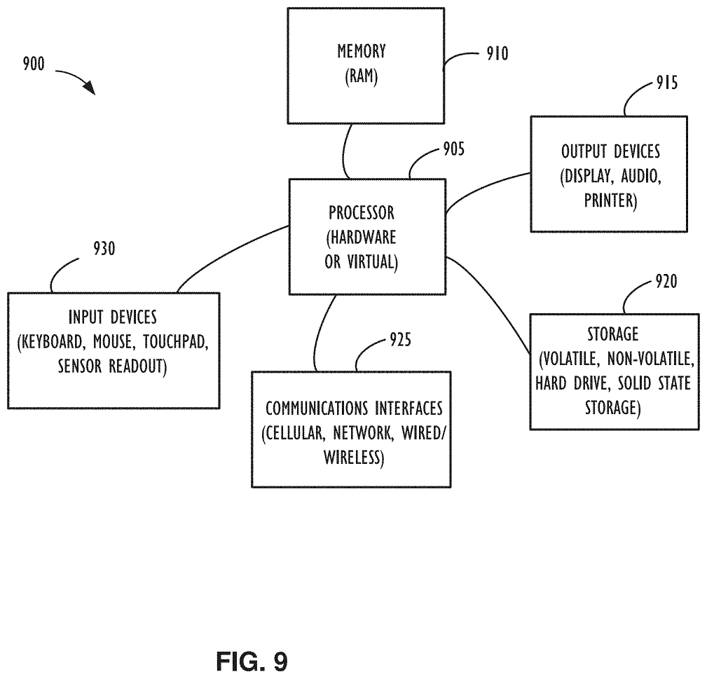

This example implementation is explained with reference to the figures and includes: an example workflow that an analyst can follow that implements methods for predicting if an order may be placed on hold (FIG. 5B); an example functional block diagram of a user interface that may be used to present predicted order holds and recommended actions (FIG. 6A); an example functional block diagram of a logical grouping of a data point that contains data that may be used to determine actions to take to prevent an order from being placed on hold or allowing a held order to be released (FIG. 6B); an example functional block diagram representing an example user interface that may be used to present a recommendation for a preventative action to minimize actualization of a predicted hold (FIG. 7A); an example functional block diagram representing an alternate view of the example user interface illustrated in FIG. 7A (FIG. 7B); an example functional block diagram representing another alternate view of the example user interface illustrated in FIG. 7A (FIG. 7C); a computer network infrastructure that may be used to implement all or part of the disclosed request or order hold prediction and held request or order release prediction algorithms, according to one or more disclosed implementations (FIG. 8); and a computer processing device that may be used to implement the functions, modules, processing platforms, execution platforms, communication devices, and other methods and processes of this disclosure (FIG. 9).

In accordance with the examples, one or more methods are described that may allow a seller to avoid placing a buyer's orders on hold, for instance methods 100A of FIG. 1A and 100B of FIG. 1B. Should an order hold be unavoidable, at least one method describes, in accordance with the examples, automating the assessment performed to determine if the buyer's credit limit should be increased so that the held order is released for delivery of goods to the buyer, for instance method 300 of FIG. 3.

To prevent orders from going on hold, a predictive algorithm may be employed. The predictive algorithm may utilize data such as the buyer's order history, history of previous order holds, and other data from the buyer's credit history to predict the date and amount of the next order that will be placed by the buyer. The predictive algorithm, using techniques such as machine learning and artificial intelligence, can produce a prediction that then may initiate an assessment of the buyer's current state in regard to credit limit. The assessment may also utilize past data such as the buyer's payment frequency to predict if an order of the predicted value of the predicted size will be likely to exceed the credit limit. The sources of the data used in the prediction may also include any public source of data in any part of the predictive algorithm's assessment. This additional data about the buyer may include news articles, social media reputations, stock quotes, or any other public or private sources of data that may contribute to increasing the accuracy of the prediction.

As a result of the prediction, a recommended course of action may be formulated based on a level of certainty that may be assigned to the predicted order date and order amount. These recommendations, for example, may include, but are not limited to, instructions such as to proactively ask the buyer for a payment, to recommend a temporary increase in the buyer's credit limit for a period of time or until an event such as the buyer placing an order has occurred, or even to perform no action in the case the prediction is that the buyer will not place an order that exceeds the credit limit. The number of recommendations may be pre-programmed instructions that are configured to be presented based, for example, on the certainty of the prediction, a time window for which the prediction is valid, or even a sliding window scale where the certainty is reduced gradually over time. The possible recommended actions and method of assigning how they are presented is without limit. This predictive analysis may be applied to a single buyer or multiple buyers concurrently so that the recommendations may be executed before an order is placed that may be put on hold. Use of artificial intelligence and machine learning leads to improved efficiency in computing systems that employ the disclosed methods. Moreover, the predictive nature of the algorithms remove the algorithms from the realm of possibility for pen and paper or manual analysis by a user.

A method, e.g., method 100A, of preventing orders from being placed on hold may allow for prediction and quickly determining one or more actions that may be taken by the seller organization, but there are some cases where an order being placed on hold is unavoidable. Some recommendations may require that the buyer participates in executing the recommendation such as when the recommendation involves contacting the buyer and requesting a payment. There are an infinite number of reasons an order hold may occur despite the best efforts to prevent the order hold. When an order is placed on hold, it may be beneficial to reduce the time required to decide a course of action that may be taken to remove the order hold.

Once an order is on hold, a Credit Department, for instance, if unaided by an automated algorithm, may be forced to spend a significant amount of time working to determine the best action to take to remove the hold on the order. Using techniques such as machine learning and artificial intelligence, the same data that is used to predict an order hold as previously described may be utilized to predict the likelihood of an order being released from hold. As a prediction is calculated about the likelihood of an order being released from hold, the system may automatically increase the buyer's credit limit thereby releasing the order from hold based on the certainty of the prediction. For example, the system may determine whether to release the hold based on whether the likelihood of the hold being released exceeds a release threshold. The system may then automatically increase a threshold or resource limit (such as a credit limit) to release or prevent the hold when the likelihood of the hold being released exceeds the release threshold. The release threshold may be based on previous or current holds for the requestor, payment history for the requestor, a credit profile for the requestor, etc. The release threshold may be expressed as an integer, a percentage, etc.

This automated increase of credit limit and release of orders on hold may significantly decrease the amount of time a person spends to research the order holds. In some examples, the system may be configured for rules that determine if a prediction should cause the order hold to be released automatically without user intervention. In other examples, the system present a decision to a user to confirm that an order should be released and present the results of the prediction to aid in choosing to release the order from hold.

Referring now to FIG. 5A, an example work process is shown to demonstrate the inefficient method 500A that a credit analyst may follow without the benefit of the disclosed methods of predicting if an order will be placed on hold. In this method 500A, block 510A shows the analyst may log into an application used to view held orders. Continuing to block 520A, the analyst may review the blocked orders. The analyst may take the next step described in block 530A where data related to the buyer's past history is retrieved for manual review. The analyst may then continue to block 540A where the decision is made to block or release the order. While the analyst is executing tasks described by blocks 520A-540A, the buyer and the sales team may be waiting for the credit analyst to finish the evaluation. The time taken to execute the tasks described in blocks 520A-540A may take many hours. Block 550A depicts that a held order is released after some time, either through the actions of a credit analyst or the buyer reducing the outstanding credit amount by making a payment against the buyer's outstanding balance. A released order can then be processed successfully as described in block 560A.

Referring now to FIG. 5B, an example work process is shown to illustrate an example method 500B. Example method 500B, which incorporates output of one or more methods according to the present disclosure, e.g., method 100A, 100B, and/or method 300, can be implemented by an analyst. Method 500B can thereby enable the order process to work more efficiently when blocked orders are prevented. In method 500B, block 510B shows the analyst may log into an application used to view held orders. Block 520B depicts the analyst reviewing predicted blocked orders instead of orders that are currently blocked. The credit analyst then proceeds to block 530B to perform the actions that are recommended based on the machine learning and artificial intelligence analysis implemented in the methods 100A, 100B, and 300 based on, for example, the buyer's order and payment history. At some time later, block 540B depicts the customer placing an order. Block 550B depicts the order being processed successfully. During the work process 500B, no buyer or sales person is waiting for the credit analyst's decision for a blocked order to be released.

Referring now to FIG. 6A, shown is a block diagram 600 of an example user interface 605 that may be presented, by an underlying executing application referred to herein as “the application” for a user to take actions for information related to buyers and their orders. For instance the interface 605 may be presented to enable selections to be made to prevent orders from being placed on hold or to increase a buyer's credit limit to enable held orders to be released. The user interface 605 may be presented as a web application in a web browser, a desktop application, or any other type of application applicable to running on any general-purpose computing device. The user interface 605 may present data showing a buyer's name as is demonstrated in the example FIG. 6A. Alternatively or additionally, the data may be shown in another format including starting with the presentation of orders, for example held orders identified as actionable by the user.

The user interface 605 may present a summary 610 at the top of the screen to enable a quick assessment of the magnitude of the number of predicted orders that may be placed on hold. This summary may include additional information such as recommendations for courses of action instead of or in addition to any summary information available. Data 615-1 through 615-4, which may be actioned by a user, may be presented in any order and format. In this example, the data 615-1 through 615-4 is presented as a summary of a buyer's predicted order that may be placed on hold. The application may allow the user to perform an action such as clicking on an area that may be logically representing a single data point for actioning. At the time of the user clicking on a logical area to perform actions on a selected data point, the application may present the user with views that lead the user into indicating the actions for the program to take.

Referring now to FIG. 6B, shown is a close up of an example of the logical grouping of a data point 615, illustrated as data point 615-4 of FIG. 6A, that contains data that may indicate an actionable item to prevent an order from being placed on hold or allow a held order to be released. The buyer's name 620 is included, for example, to allow a user to orient quickly on the point of data. The buyer's name 620 is shown in this example, but any information may be presented here for the purpose of allowing a user to orient quickly on the point of data. A gauge 625 may be included to indicate the utilization of the buyer's credit limit as a percentage, in accordance with the example. The buyer's credit rating 630 and short summary 635 may also be included as additional points of data that allow a user to orient on the data point in accordance with the logical grouping of data.

Referring now to FIG. 7A, shown is an example block diagram 700 of a detailed view of a data point shown for summary and user orientation purposes in the user interface 605 described in FIG. 6A. This user interface may present a more detailed view and more detailed data that may assist the user in decision making once the user has been oriented to focus on a data point. In this example, element 635 described in FIG. 6B may be displayed along with other data elements that may help a user understand the actions that may be taken to prevent an order from being put on hold or to release an order from hold. Additional summary information 705 may augment summary information 635 to aid the user in recognizing the reason the order hold may have been predicted or an order may have been put on hold. Navigational controls 710 and 740 may be used by the user to change views or return to a previous view. Indicator 725 may indicate one of many views available is displaying such as the view of the prediction for an order hold 735 in this example.

The prediction for an order hold 735 may include information such as the credit exposure that may allow the user to understand the total amount of money extended as credit to the customer. This credit exposure may be the result of a calculation of all open invoices that are not yet paid and all orders that may be in the process of fulfillment that have not yet been billed. The prediction for an order hold 735 may additionally include the credit limit assigned to the buyer that allows the seller to limit the credit exposure to the buyer. Recommendations 730 may indicate the recommended course of action that the user may take by selecting button 715. An input to the application from the button 715 being selected may apply the recommendation to a buyer's account. Alternatively, and input to the application from the user selecting button 720 may display a more detailed user interface that may allow the user to implement all or part of the recommendation 730.

Referring now to FIG. 7B, shown is an example block diagram representing an alternate view of the example user interface described in FIG. 7A. The indicator 725 may change to indicate to the user that the display has changed to show balance history graph 745. FIG. 7B contains some identical indications and buttons as FIG. 7A. Accordingly, the description above with respect to these identical indications and buttons as apply to the view shown in FIG. 7A apply equally to the alternative view shown in FIG. 7B.

Referring now to FIG. 7C, shown is an example block diagram representing another alternate view of the example user interface described in FIG. 7A. The indicator 725 may again change to indicate to the user that the display has changed to show order history of the buyer 750. FIG. 7 contains some identical indications and buttons as FIG. 7A. Accordingly, the description above with respect to these identical indications and buttons as apply to the view shown in FIG. 7A apply equally to the alternative view shown in FIG. 7C.

FIGS. 7A-7C represent some examples of the possibilities of what may be shown to a user as part of data display to help a user prevent order holds or release held orders. The examples are not intended to limit the data that may be presented to the user to assist in preventing order holds or releasing held orders.

FIG. 8 represents a computer network infrastructure that may be used to implement all or part of the disclosed order hold prevention and held order release prediction techniques, according to one or more disclosed implementations. Network infrastructure 800 includes a set of networks where embodiments of the present disclosure may operate. Network infrastructure 800 comprises a customer network 802, network 808, cellular network 803, and a cloud service provider network 810. In one embodiment, the customer network 802 may be a local private network, such as local area network (LAN) that includes a variety of network devices that include, but are not limited to switches, servers, and routers.

Each of these networks can contain wired or wireless programmable devices and operate using any number of network protocols (e.g., TCP/IP) and connection technologies (e.g., WiFi® networks, or Bluetooth®. In another embodiment, customer network 802 represents an enterprise network that could include or be communicatively coupled to one or more local area networks (LANs), virtual networks, data centers and/or other remote networks (e.g., 808, 810). In the context of the present disclosure, customer network 802 may include multiple devices configured with software that executes the disclosed order hold prevention and held order release prediction algorithms such as those described above. Also, one of the many computer storage resources in customer network 802 (or other networks shown) may be configured to store any customer or order data utilized by any algorithm described in the disclosed examples.

As shown in FIG. 8, customer network 802 may be connected to one or more client devices 804A-E and allow the client devices 804A-E to communicate with each other and/or with cloud service provider network 810, via network 808 (e.g., Internet). Client devices 804A-E may be computing systems such as desktop computer 804B, tablet computer 804C, mobile phone 804D, laptop computer (shown as wireless) 804E, and/or other types of computing systems generically shown as client device 804A.

Network infrastructure 800 may also include other types of devices generally referred to as Internet of Things (IoT) (e.g., edge IOT device 805) that may be configured to send and receive information via a network to access cloud computing services or interact with a remote web browser application (e.g., to receive configuration information).

FIG. 8 also illustrates that customer network 802 includes local compute resources 806A-C that may include a server, access point, router, or other device configured to provide for local computational resources and/or facilitate communication amongst networks and devices. For example, local compute resources 806A-C may be one or more physical local hardware devices, such as the different configurations of NN processing systems outlined above. Local compute resources 806A-C may also facilitate communication between other external applications, data sources (e.g., 807A and 807B), and services, and customer network 802. Local compute resource 806C illustrates a possible processing system cluster with three nodes. Of course, any number of nodes is possible, but three are shown in this example for illustrative purposes.

Network infrastructure 800 also includes cellular network 803 for use with mobile communication devices. Mobile cellular networks support mobile phones and many other types of mobile devices such as laptops etc. Mobile devices in network infrastructure 800 are illustrated as mobile phone 804D, laptop computer 804E, and tablet computer 804C. A mobile device such as mobile phone 804D may interact with one or more mobile provider networks as the mobile device moves, typically interacting with a plurality of mobile network towers 820, 830, and 840 for connecting to the cellular network 803. In the context of the current disclosed order hold prediction and held order release prediction algorithms, operations to access and process data may be facilitated by systems communicating through network infrastructure 800.

Although referred to as a cellular network in FIG. 8, a mobile device may interact with towers of more than one provider network, as well as with multiple non-cellular devices such as wireless access points and routers (e.g., local compute resources 806A-C). In addition, the mobile devices may interact with other mobile devices or with non-mobile devices such as desktop computer 804B and various types of client device 804A for desired services. Although not specifically illustrated in FIG. 8, customer network 802 may also include a dedicated network device (e.g., gateway or router) or a combination of network devices (not shown) that implement a customer firewall or intrusion protection system. These types of devices may be configured to provide an interface to an event management processing and throttling system of this disclosure.

FIG. 8 illustrates that customer network 802 is coupled to a network 808. Network 808 may include one or more computing networks available today, such as other LANs, wide area networks (WAN), the Internet, and/or other remote networks, in order to transfer data between client devices 804A-D and cloud service provider network 810. Each of the computing networks within network 808 may contain wired and/or wireless programmable devices that operate in the electrical and/or optical domain.

In FIG. 8, cloud service provider network 810 is illustrated as a remote network (e.g., a cloud network) that is able to communicate with client devices 804A-E via customer network 802 and network 808. The cloud service provider network 810 acts as a platform that provides additional computing resources to the client devices 804A-E and/or customer network 802. In one embodiment, cloud service provider network 810 includes one or more data centers 812 with one or more server instances 814.

FIG. 9 illustrates a computer processing device 900 that may be used to implement the functions, modules, processing platforms, execution platforms, communication devices, and other methods and processes of this disclosure. For example, computing device 900 illustrated in FIG. 9 could represent a client device or a physical server device and include either hardware or virtual processor(s) depending on the level of abstraction of the computing device. In some instances (without abstraction), computing device 900 and its elements, as shown in FIG. 9, each relate to physical hardware. Alternatively, in some instances one, more, or all of the elements could be implemented using emulators or virtual machines as levels of abstraction. In any case, no matter how many levels of abstraction away from the physical hardware, computing device 900 at its lowest level may be implemented on physical hardware.

As also shown in FIG. 9, computing device 900 may include one or more input devices 930, such as a keyboard, mouse, touchpad, or sensor readout (e.g., biometric scanner) and one or more output devices 915, such as displays, speakers for audio, or printers. Some devices may be configured as input/output devices also (e.g., a network interface or touchscreen display).

Computing device 900 may also include communications interfaces 925, such as a network communication unit that could include a wired communication component and/or a wireless communications component, which may be communicatively coupled to processor 905. The network communication unit may utilize any of a variety of proprietary or standardized network protocols, such as Ethernet, TCP/IP, to name a few of many protocols, to effect communications between devices. Network communication units may also comprise one or more transceiver(s) that utilize the Ethernet, power line communication (PLC), WiFi, cellular, and/or other communication methods.

As illustrated in FIG. 9, computing device 900 includes a processing element such as processor 905 that contains one or more hardware processors, where each hardware processor may have a single or multiple processor cores. In one embodiment, the processor 905 may include at least one shared cache that stores data (e.g., computing instructions) that are utilized by one or more other components of processor 905. For example, the shared cache may be a locally cached data stored in a memory for faster access by components of the processing elements that make up processor 905. In one or more embodiments, the shared cache may include one or more mid-level caches, such as level 2 (L2), level 3 (L3), level 4 (L4), or other levels of cache, a last level cache (LLC), or combinations thereof. Examples of processors include but are not limited to a central processing unit (CPU) a microprocessor. Although not illustrated in FIG. 9, the processing elements that make up processor 905 may also include one or more of other types of hardware processing components, such as graphics processing units (GPU), application specific integrated circuits (ASICs), field-programmable gate arrays (FPGAs), and/or digital signal processors (DSPs).

FIG. 9 illustrates that memory 910 may be operatively and communicatively coupled to processor 905. Memory 910 may be a non-transitory medium configured to store various types of data. For example, memory 910 may include one or more storage devices 920 that comprise a non-volatile storage device and/or volatile memory. Volatile memory, such as random-access memory (RAM), can be any suitable non-permanent storage device. The non-volatile storage devices 920 can include one or more disk drives, optical drives, solid-state drives (SSDs), tap drives, flash memory, read only memory (ROM), and/or any other type of memory designed to maintain data for a duration of time after a power loss or shut down operation. In certain instances, the non-volatile storage devices 920 may be used to store overflow data if allocated RAM is not large enough to hold all working data. The non-volatile storage devices 920 may also be used to store programs that are loaded into the RAM when such programs are selected for execution.

Persons of ordinary skill in the art are aware that software programs may be developed, encoded, and compiled in a variety of computing languages for a variety of software platforms and/or operating systems and subsequently loaded and executed by processor 905. In one embodiment, the compiling process of the software program may transform program code written in a programming language to another computer language such that the processor 905 is able to execute the programming code. For example, the compiling process of the software program may generate an executable program that provides encoded instructions (e.g., machine code instructions) for processor 905 to accomplish specific, non-generic, particular computing functions.

After the compiling process, the encoded instructions may then be loaded as computer executable instructions or process steps to processor 905 from storage device 920, from memory 910, and/or embedded within processor 905 (e.g., via a cache or on-board ROM). Processor 905 may be configured to execute the stored instructions or process steps in order to perform instructions or process steps to transform the computing device into a non-generic, particular, specially programmed machine or apparatus. Stored data, e.g., data stored by a storage device 920, may be accessed by processor 905 during the execution of computer executable instructions or process steps to instruct one or more components within the computing device 900.

A user interface (e.g., output devices 915 and input devices 930) can include a display, positional input device (such as a mouse, touchpad, touchscreen, or the like), keyboard, or other forms of user input and output devices. The user interface components may be communicatively coupled to processor 905. When the output device is or includes a display, the display can be implemented in various ways, including by a liquid crystal display (LCD) or a cathode-ray tube (CRT) or light emitting diode (LED) display, such as an organic light emitting diode (OLED) display. Persons of ordinary skill in the art are aware that the computing device 900 may comprise other components well known in the art, such as sensors, powers sources, and/or analog-to-digital converters, not explicitly shown in FIG. 9.

Certain terms have been used throughout this description and claims to refer to particular system components. As one skilled in the art will appreciate, different parties may refer to a component by different names. This document does not intend to distinguish between components that differ in name but not function. In this disclosure and claims, the terms “including” and “comprising” are used in an open-ended fashion, and thus should be interpreted to mean “including, but not limited to . . . .” Also, the term “couple” or “couples” is intended to mean either an indirect or direct wired or wireless connection. Thus, if a first device couples to a second device, that connection may be through a direct connection or through an indirect connection via other devices and connections. The recitation “based on” is intended to mean “based at least in part on.” Therefore, if X is based on Y, X may be a function of Y and any number of other factors.

The above discussion is meant to be illustrative of the principles and various implementations of the present disclosure. Numerous variations and modifications will become apparent to those skilled in the art once the above disclosure is fully appreciated. It is intended that the following claims be interpreted to embrace all such variations and modifications.

What is claimed is:

1. A computer-implemented method for predictive resource request hold and proactive hold resolution, the computer-implemented method comprising:
retrieving historical data of previous requests for a resource by a requestor;
retrieving additional data for the requestor;
predicting, based on the historical data of previous requests, a future request for the resource from the requestor;
predicting, based on the future request for the resource and the additional data for the requestor, a hold on fulfilling the future request; and
determining a preventative action to minimize an actualization of the hold on fulfilling the future request.

2. The computer-implemented method of claim 1, wherein the additional data for the requestor comprises a resource limit assigned to the requestor.

3. The computer-implemented method of claim 2, wherein the additional data for the requestor comprises a payment history for the requestor.

4. The computer-implemented method of claim 3, further comprising:
predicting, based on the payment history, a future payment for the resource; and
wherein predicting the hold on fulfilling the future request is based on the predicted future payment for the resource.

5. The computer-implemented method of claim 4, wherein the additional data for the requestor comprises an outstanding payment balance for the requestor, the method further comprising:
predicting a date and amount of the future request based on the historical data of previous requests;
predicting a date and amount of the future payment based on the payment history; and
predicting the hold on fulfilling the future request based on the date and amount of the future request, the date and amount of the future payment, the resource limit, and the outstanding payment balance.

6. The computer-implemented method of claim 2, wherein the preventive action comprises temporarily adjusting the resource limit assigned to the requestor.

7. The computer-implemented method of claim 6, wherein the resource limit comprises a credit limit, and the preventative action comprises temporarily increasing the credit limit.

8. The computer-implemented method of claim 1, further comprising:
presenting the preventative action as a recommendation through a user interface; and
applying the preventative action in response to input through the user interface.

9. The computer-implemented method of claim 1, further comprising:
automatically, without user input, applying the preventative action; and
updating an account for the requestor based on the applied preventative action.

10. The computer-implemented method of claim 1, further comprising:
actualizing the hold;
detecting the actualization of the hold;
predicting a likelihood of the hold being released; and
determining whether to release the hold based on whether the likelihood of the hold being released exceeds a release threshold.

11. The computer-implemented method of claim 10, further comprising:
determining that the likelihood of the hold being released exceeds the release threshold; and
automatically, without user input, increasing a threshold limit associated with the resource to prevent the hold.

12. The computer-implemented method of claim 11, wherein automatically increasing the threshold limit comprises automatically increasing a credit limit.

13. The computer-implemented method of claim 1, wherein the previous requests for a resource comprises previous orders for a buyer, the future request comprises a future order for the buyer, and the additional data for the requestor comprises a credit limit assigned to the buyer, a payment history for the buyer, and an outstanding payment balance for the buyer, the method further comprising:
predicting, based on the previous orders, an amount and date of the future order;
predicting, based on the payment history, an amount and date of a next payment from the buyer; and
predicting the hold on fulfilling the future order based on the predicted amount and date of the future order, the predicted amount and date of the next payment, the credit limit assigned to the buyer, and the outstanding payment balance for the buyer.

14. A non-transitory computer-readable storage medium including executable instructions that, when executed by a processor, cause the processor to:
detect the actualization of a hold on a request for a resource by a requestor;
predict a likelihood of the hold being released;
determine whether to release the hold based on the likelihood of the hold being released; and
automatically increase a resource limit associated with the resource, to release the hold, when the likelihood of the hold being released exceeds a release threshold.

15. The non-transitory computer-readable storage medium of claim 14, wherein the actualization of the hold is based on a predicted future request for the resource from the requestor, wherein the executable instructions, when executed by the processor, cause the processor to:
retrieve historical data of previous requests for the resource by the requestor;
retrieve additional data for the requestor;
predict, based on the historical data of previous requests, the future request for the resource; and
predict, based on the future request for the resource and the additional data for the requestor, actualization of a hold on fulfilling the future request.

16. The non-transitory computer-readable storage medium of claim 15, wherein the previous requests for a resource comprises previous orders for a buyer, the future request comprises a future order for the buyer, and the additional data for the requestor comprises a credit limit assigned to the buyer, a payment history for the buyer, and an outstanding payment balance for the buyer, wherein the executable instructions, when executed by the processor, cause the processor to:
predict, based on the previous orders, an amount and date of the future order;
predict, based on the payment history, an amount and date of a next payment from the buyer; and
predict, the actualization of the hold on fulfilling the future order based on the predicted amount and date of the future order, the predicted amount and date of the next payment, the credit limit assigned to the buyer, and the outstanding payment balance for the buyer.

17. A computing device comprising:
a processor;
a non-transitory computer-readable storage medium including executable instructions that, when executed by a processor, cause the processor to:
retrieve historical data of previous requests for a resource by a requestor;
retrieve, additional data for the requestor, the additional data comprising a payment history for the requestor;
predict, based on the historical data of previous requests, a future request for the resource from the requestor;
predict, based on the payment history, a future payment for the resource;
predict, based on the future request for the resource and the future payment for the resource, a hold on fulfilling the future request; and
determine a preventative action to minimize actualization of the hold on fulfilling the future request.

18. The computing device of claim 17, wherein the previous requests for a resource comprises previous orders for a buyer, the future request comprises a future order for the buyer, the payment history for the requestor comprises a payment history for the buyer, and the additional data for the requestor further comprises a credit limit assigned to the buyer and an outstanding payment balance for the buyer, wherein the executable instructions, when executed by the processor, cause the processor to:
predict, based on the previous orders, an amount and date of the future order;
predict, based on the payment history, an amount and date of a next payment from the buyer; and
predict the hold on fulfilling the future order based on the predicted amount and date of the future order, the predicted amount and date of the next payment, the credit limit assigned to the buyer, and the outstanding payment balance for the buyer.

19. The computing device of claim 18, wherein the preventative action comprises temporarily increasing the credit limit, wherein the executable instructions, when executed by the processor, cause the processor to:
present the preventative action as a recommendation through a user interface; and
apply the preventative action in response to input through the user interface.

20. The computing device of claim 18, wherein the preventative action comprises temporarily increasing the credit limit, wherein the executable instructions, when executed by the processor, cause the processor to:
automatically, without user input, apply the preventative action; and
update an account for the requestor based on the applied preventative action.
